(19) United States
(12) Patent Application Publication
(10) Pub. No.: US 2013/0117719 A1
(43) Pub. Date: May 9, 2013

(54) Context-Based Adaptation for Business Applications

(71) Applicants: Julia Bender, Oestringen (DE); Christian Guenther, Hockenheim (DE); Ralf Kaltenmaier, Wiesloch (DE)

(72) Inventors: Julia Bender, Oestringen (DE); Christian Guenther, Hockenheim (DE); Ralf Kaltenmaier, Wiesloch (DE)

(73) Assignee: SAP AG, Walldorf (DE)

(21) Appl. No.: 13/290,878

(22) Filed: Nov. 7, 2011

(51) Int. Cl. G06F 3/01

(52) U.S. Cl. 715/866

(57) ABSTRACT

The present disclosure describes methods, systems, and computer program products for providing context-based adaptations in business applications. One example method includes identifying an executing instance of an application associated with at least one adaptation configuration, where each adaptation configuration is associated with a set of context criteria. An environmental context associated with the executing instance of the application is determined. A request to perform an operation of the application is received, and a comparison of the environmental context is made with the at least one adaptation configuration to determine if the environmental context satisfies the set of context criteria. The at least one adaptation configuration is then applied for the performance of the operation based on the environmental context satisfying the set of context criteria.

### TECHNICAL FIELD

The present disclosure relates to software, computer systems, and computer-implemented methods for context-based adaptation of software applications.

### BACKGROUND

Software development in a distributed enterprise development environment involves tens, hundreds, or thousands of developers each working on different portions of the same, or related, applications. Many of these platforms and applications may require information suited for different standards, administrators, and users. Certain overall adaptations modified to the existing platform or base application can be implemented at design stage or during runtime. At present, the adaptations may be deployed unrelated to the contents of the existing platform or base application.

### SUMMARY

The present disclosure describes methods, systems, and computer program products for modifying an application user interface by using context-based adaptations (CBAs). One example method includes identifying an executing instance of an application associated with at least one adaptation configuration, where each adaptation configuration is associated with a set of context criteria. An environmental context associated with the executing instance of the application is determined. A request to perform an operation of the application is received, and a comparison of the environmental context is made with the at least one adaptation configuration to determine if the environmental context satisfies the set of context criteria. The at least one adaptation configuration is then applied for the performance of the operation based on the environmental context satisfying the set of context criteria.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example environment for implementing various features of a business application system providing context-based adaptations.

FIG. 2 provides an example illustration of an adaptation implementation hierarchy.

FIG. 3 illustrates an example configuration at various execution levels.

FIG. 4 is a flowchart of an example method 400 for adding an attachment user interface building block for an adaptation context.

FIG. 5 is a flowchart of an example method 500 for initiating an adaptation address layout.

FIGS. 6 A-E are example screenshots of applying context-based adaptation in a business application environment.

### DETAILED DESCRIPTION

This disclosure generally relates to software, computer systems, and computer-implemented methods for distributed platform development. Specifically, tools and methods are used to adapt a graphical user interface (GUI) created in a distributed development environment, and allow for a context-based adaptation in an associated consolidated platform development system. Additionally, object models generated in and for other applications and environments can be modified and generated using the context-based adaptations. The present disclosure can reduce the development costs by allowing developers, administrators and users to modify objects and their associated models based on the design, structure, and inherent characteristics of a pre-defined adaptation context. In addition to reducing the effort in programming and developing applications in an environment to suit each individual administrator or user in a particular environment, the present disclosure also enables developers, administrators, and users to deploy context-based adaptations at various hierarchy levels in design and/or runtime environments.

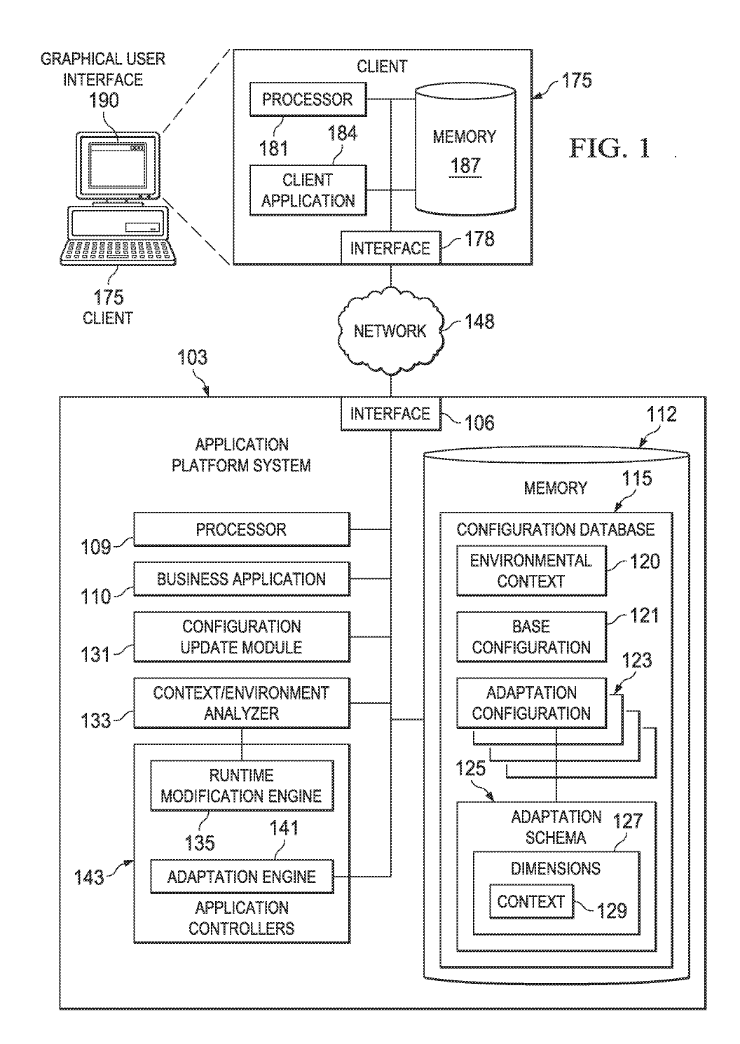

FIG. 1 illustrates an example environment 100 for implementing various features of a system providing context-based adaptations. The illustrated environment 100 includes, or is communicably coupled with, a context-based adaptation server 103 and at least one client 175. At least some of the communications between the context-based adaptation server 103 and the client 175 may be performed across or via network 148. In general, environment 100 depicts an example configuration of a system for analyzing newly developed entities and/or objects with one or more preexisting entities or objects available in related systems, such as the context-based adaptation server 103. The environment 100 is an example, and in alternative implementations, the elements illustrated in FIG. 1 may be included in or associated with different and/or additional servers, clients, networks, and locations other than those as shown. For example, one or more of the components illustrated within the context-based adaptation server 103 may be located in multiple or different servers, cloud-based networks, or other locations accessible to the context-based adaptation server 103 (e.g., either directly or indirectly via network 148).

In general, the context-based adaptation server 103 is any server or system that stores, manages, and executes functionality associated with a business application 110 and a configuration update module 131. Additionally, the context-based adaptation server 103 may execute one or more business applications 110. For example, each context-based adaptation server 103 may be a Java 2 Platform, Enterprise Edition (J2EE)-compliant application server that includes Java technologies such as Enterprise JavaBeans (EJB), J2EE Connector Architecture (JCA), Java Messaging Service (JMS), Java Naming and Directory Interface (JNDI), and Java Database Connectivity (JDBC). In some instances, each context-based adaptation server 103 may store a plurality of various applications, while in other instances, context-based adaptation servers 103 may be dedicated servers meant to store and execute the context-based adaptations for a particular platform or application and its related functionality. For example, the context-based adaptation server 103 may enable developers, administrators and users to create adaptation configurations that can be launched and modified to generate various user interface schemes based on certain context. In some instances, the context-based adaptation server 103 may comprise a web server or be communicably coupled with a web server, where one or more of the business applications 110 associated with the context-based adaptation server 103 represent web-based (or web-accessible) applications accessed and executed through requests and interactions received on the client 175, executing a client application 184 operable to interact with the programmed tasks or one or more business applications 110.

At a high level, the context-based adaptation server 103 comprises an electronic computing device operable to receive, transmit, process, store, or manage data and information associated with the environment 100. The context-based adaptation server 103 illustrated in FIG. 1 can be responsible for receiving application-related requests from one or more clients 175 (as well as any other entity or system interacting with the context-based adaptation server 103, including desktop or mobile client systems), responding to the received requests by processing said requests in the associated business application 110, and sending the appropriate responses from the appropriate component back to the requesting client 175 or other requesting system. Components of the context-based adaptation server 103 can also process and respond to local requests from a user locally accessing the server 103. Accordingly, in addition to requests from the client 175 illustrated in FIG. 1, requests associated with a particular component may also be sent from internal users, external or third-party customers, and other associated business applications, business processes, as well as any other appropriate entities, individuals, systems, or computers. In some instances, the business application 110 may be web-based applications executing functionality associated with a networked or cloud-based business process.

As used in the present disclosure, the term “computer” is intended to encompass any suitable processing device. For example, although FIG. 1 illustrates a single context-based adaptation server 103, environment 100 can be implemented using any number of servers, as well as computers other than servers, including a server pool. Indeed, the context-based adaptation server 103 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, the illustrated context-based adaptation server 103 may be adapted to execute any operating system, including Linux, UNIX, Windows, Mac OS, iOS, or any other suitable operating system.

In the illustrated implementation of FIG. 1, the context-based adaptation server 103 includes an interface 106, a processor 109, a memory 112, a business application 110, a configuration update module 131, a context/environment analyzer 133, and an adaptation engine 141. In some instances, the context-based adaptation server 103 and its illustrated components may be separated into multiple components executing at different servers and/or systems. For example, while FIG. 1 illustrates the business application 110 and the configuration update module 131 as separate components, other example implementations can include the configuration update module 131 within a separate system, as well as within as part of the business application's inherent functionality. Thus, while illustrated as a single component in the example environment 100 of FIG. 1, alternative implementations may illustrate the context-based adaptation server 103 as comprising multiple parts or portions, accordingly.

FIG. 1 depicts a server-client environment, but could also represent a cloud computing network. Various other implementations of the illustrated environment 100 can be provided to allow for increased flexibility in the underlying system, including multiple context-based adaptation servers 103 performing or executing one or more additional or alternative instances of the configuration update module 131 and associated with a context/environment analyzer 133 for one or more different platforms, as well as multiple instances of the business application 110 and its related functionality. In those instances, the different context-based adaptation servers 103 may communicate with each other via a cloud-based network or through the connections provided by network 148.

The interface 106 is used by the context-based adaptation server 103 to communicate with other systems in a client-server or other distributed environment (including within environment 100) connected to the network 148 (e.g., one of the clients 175, as well as other systems communicably coupled to the network 148). The interface 106 generally comprises logic encoded in software and/or hardware in a suitable combination and operable to communicate with the network 148. More specifically, the interface 106 may comprise software supporting one or more communication protocols associated with communications such that the network 148 or the interface's hardware is operable to communicate physical signals within and outside of the illustrated environment 100.

Generally, the context-based adaptation server 103 may be communicably coupled with a network 148 that facilitates wireless or wireline communications between the components of the environment 100 (i.e., between the context-based adaptation server 103 and one or more clients 175), as well as with any other local or remote computer, such as additional clients, servers, or other devices communicably coupled to network 148, including those not illustrated in FIG. 1. In the illustrated environment, the network 148 is depicted as a single network, but may be comprised of more than one network without departing from the scope of this disclosure, so long as at least a portion of the network 148 may facilitate communications between senders and recipients. In some instances, one or more of the components associated with the context-based adaptation server 103 may be included within the network 148 as one or more cloud-based services or operations.

The network 148 may be all or a portion of an enterprise or secured network, while in another instance, at least a portion of the network 148 may represent a connection to the Internet. In the illustrated example, at least a portion of the network 148 includes a portion of a cellular or mobile data network or other network capable of relaying SMS messages. In some instances, a portion of the network 148 may be a virtual private network (VPN). Further, all or a portion of the network 148 can comprise either a wireline or wireless link. Example wireless links may include 802.11/b/g/n, 802.20, WiMax, and/or any other appropriate wireless link. In other words, the network 148 encompasses any internal or external network, networks, sub-network, or combination thereof operable to facilitate communications between various computing components inside and outside the illustrated environment 100. The network 148 may communicate, for example, Internet Protocol (IP) packets, Frame Relay frames, Asynchronous Transfer Mode (ATM) cells, voice, video, data, and other suitable information between network addresses. The network 148 may also include one or more local area networks (LANs), radio access networks (RANs), metropolitan area networks (MANs), wide area networks (WANs), all or a portion of the Internet, and/or any other communication system or systems at one or more locations.

As illustrated in FIG. 1, the context-based adaptation server 103 includes a processor 109. Although illustrated as a single processor 109 in the context-based adaptation server 103, two or more processors may be used in the context-based adaptation server 103 according to particular needs, desires, or particular embodiments of environment 100. The processor 109 may be a central processing unit (CPU), a blade, an application specific integrated circuit (ASIC), a field-programmable gate array (FPGA), or another suitable component. Generally, the processor 109 executes instructions and manipulates data to perform the operations of the context-based adaptation server 103 and, specifically, the functionality associated with the corresponding business application 110 and the configuration update module 131. In one implementation, the server's processor 109 executes the functionality required to receive and respond to requests and instructions from the client 175, as well as the functionality required to perform the operations of the associated business application 110 and the configuration update module 131, among others.

Regardless of the particular implementation, “software” may include computer-readable instructions, firmware, wired or programmed hardware, or any combination thereof on a tangible and non-transitory medium operable when executed to perform at least the processes and operations described herein. Indeed, each software component may be fully or partially written or described in any appropriate computer language including C, C++, Java, Visual Basic, assembler, Perl, any suitable version of 4GL, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components, as appropriate. In the illustrated environment 100, each processor 109 executes the corresponding configuration update module 131 and the business application 110 stored on the associated context-based adaptation server 103. In some instances, a particular context-based adaptation server 103 may be associated with the execution of two or more business applications 110 (and other related components), as well as one or more distributed applications executing across two or more servers executing the functionality associated with the context-based adaptation server 103.

At a high level, each business application 110 is any application, program, module, process, or other software that may execute, change, delete, generate, or otherwise manage information associated with a particular context-based adaptation server 103, and in some cases, a business process performing and executing business process-related events. In particular, business processes communicate with other users, applications, systems, and components to send, receive, and process events. In some instances, a particular business application 110 may operate in response to and in connection with one or more requests received from an associated client 175 or other remote client. Additionally, a particular business application 110 may operate in response to and/or in connection with one or more requests received from other business applications 110 external to the context-based adaptation server 103. In some instances, the business application 110 may request additional processing or information from an external system or application. In some instances, one of more of the business applications 110 may represent a web-based application accessed and be executed by remote clients 175 via the network 148 (e.g., through the Internet, or via one or more cloud-based services associated with the business application 110). Further, while illustrated as internal to the context-based adaptation server 103, one or more processes associated with a particular business application 110 may be stored, referenced, or executed remotely. For example, a portion of a particular business application 110 may be a web service that is remotely called, while another portion of the business application 110 may be an interface object or agent bundled for processing at a remote system (not illustrated), or a particular client 175 (e.g., the client application 184). Moreover, any or all of a particular business application 110 may be a child or sub-module of another software module or enterprise application (not illustrated) without departing from the scope of this disclosure. Still further, portions of the particular business application 110 may be executed or accessed by a user working directly at the context-based adaptation server 103, as well as remotely at a corresponding client 175.

The illustrated business application 110 may be created and developed based on an underlying software platform or platform layer, which can be used to provide underlying functionality defined by the platform, as well as additional functionality available by building software applications upon the platform layer using components and entities originally designed for use with the platform. By creating the additional functionality, the platform can be extended and added to by a plurality of developers, providing for a fluid means of enhancement. In some instances, additional applications can be built on top of the original system by many different developers and development teams to create new products and software. The configuration update module 131, the context/environment analyzer 133 and the adaptation engine 141 can create context-based adaptations to the applications.

In some implementations, the business application 110 may include the configuration update module 131, a context/environment analyzer 133 and an adaptation engine 141. The configuration update module 131 may tailor the business application 110 according to an adaptation context or environment analyzed by the context/environment analyzer 133 and executed at the adaptation engine 141. The context/environment analyzer 133 may further include a runtime modification engine 135 which enables modification of the adaptation context at runtime. The runtime modification engine 135 and the adaptation engine 141 may be grouped as the application controllers 143.

The configuration update module 131 may include execution codes to modify user interface building blocks (UIBBs). UIBBs can be any display component shown along with or presented in associated with the running of the business application 110. The configuration update module 131 may communicate with a floor plan manager (FPM) of the business application 110. The FPM may generate one or more UIBBs based on default global configurations. For example, the business application 110 may display a predetermined user interface including a number of UIBBs at runtime. The configuration update module 131 may apply context-based adaptation configurations to the UIBBs by adding additional building blocks, or hiding specified building blocks, or both. In some implementations, added building blocks may be used to replace hidden building blocks to create an adapted user interface.

The context/environment analyzer 133 may perform operations including analyzing processes, comparing the current environment of the business application 110 with the adaptation context defined by the adaptation configuration 123, and identifying the differences for adaptation by the FPM when creating UIBBs. For example, in some implementations, the current environment may be regarding or associated with a particular format of a first country (e.g., France), such as an address format, a document format, and others, while the adaptation configuration 123 may require the same content to be in compliance with standards of another, second country (e.g., Germany). The context/environment analyzer 133 may contain and/or access detailed standardized information about a plurality of environments and may identify input information for matching each standard, such as a particular order for text(e.g., for street addresses), a type of letter case or punctuation (e.g., the common punctuation used for currency), a standard number of digits for various information (e.g., telephone numbers), as well as other standard-based information. The context/environment analyzer 133 may first examine received user input, convert the received input into a unified format, identify context/environment requirements, and send the analysis results to the adaptation engine 141.

In some implementations, the context/environment analyzer 133 may include a runtime modification engine 135. The runtime execution engine 135 can provide runtime support for the configuration update module 131 and provide accessibility to the context/environment analyzer 133. The runtime execution engine 135 can perform initial determinations of the current meta-object or model being analyzed at runtime. The context analyses performed by the context/environment analyzer 133 can be tailored to the particular category of meta-object being analyzed, such that a determination of the category is an appropriate first operation of the analysis. Examples of possible objects include user interfaces, business objects, analytical views, and inbound and/or outbound agents, among others.

Once the particular category of object is determined or identified, the context/environment analyzer 133 can apply the appropriate algorithm to the object to perform a semantic analysis. In some instances, the context/environment analyzer 133 may be a part of the runtime modification engine layer's inherent functionality, while in others, the context/environment analyzer 133 may be a distinct component associated with the runtime modification engine 135. The runtime execution engine 135 may further include transactional services to create and administer business objects and other entity instances, and lifecycle service to manage object lifecycles.

The adaptation engine 141 may execute context-based adaptations at design stage or during runtime. The adaptation engine 141 may communicate directly with the FPM of the business application 110 and generate UIBBs according to corresponding adaptation configurations. In some implementations, the adaptation engine 141 and the runtime modification engine 135 can be grouped together into a set of application controllers 143. The application controllers 143 may modify the business application 110 according to execution input from developers, administrators, and users alike.

FIG. 1 further includes memory 112. The memory 112 of the context-based adaptation server 103 stores data and program instructions, as well as metadata associated with configuration update module 131. The memory 112 may include any memory or database module and may take the form of volatile or non-volatile memory including, without limitation, magnetic media, optical media, random access memory (RAM), read-only memory (ROM), removable media, or any other suitable local or remote memory component. The memory 112 may store various objects, object models, and data, including classes, frameworks, applications, backup data, business objects, jobs, web pages, web page templates, database tables, process contexts, repositories storing services local to the context-based adaptation server 103, and any other appropriate information including any parameters, variables, algorithms, instructions, rules, constraints, or references thereto associated with the purposes of the context-based adaptation server 103 and its functionality. In some implementations, including a cloud-based system, some or all of the memory 112 may be stored remote from the context-based adaptation server 103, and communicably coupled to the context-based adaptation server 103 for usage. Specifically, memory 112 can store configuration update module 131, as well as a configuration database 115. Some or all of the elements illustrated within memory 112 may be stored external to the memory 112. As illustrated, the configuration database 115 can include a base configuration 121 and one or more adaptation configurations 123, among others. These items are made accessible to the configuration update module 131.

The configuration database 115 may be accessible by different modules within the context-based adaptation server 103, as well as by external sources such as the client 175 as shown in FIG. 1. The configuration database 115 may contain various versions of its contents in history, such as updated versions of the base configuration 121 and the previous versions. The configuration database 115 may be configured such that only a shared portion may be accessed by other modules, or by different level of users, administrators, and developers. Although in FIG. 1 only one configuration database 115 is illustrated in the memory 112, a collection of more than one configuration databases may be stored in the memory 112.

The configuration database 115 may include an environmental context 120. The environmental context 120 may be a set of definitions describing the environment for the business application 110 may be used. For example, the environmental context 120 may include geographical information, time-zone information, user properties (e.g., developer, administrator, identifiable users, guest, etc.), level of clearance, security restrictions, and other environmental context information. The environmental context 120 may include a set of data associated with the base configuration 121. The set of data may define the default mode executed using the base configuration.

The configuration database 115 may include a base configuration 121 and at least one adaptation configuration 123. The base configuration 121 may contain original and updated configuration information for the business application 110. The base configuration 121 may be uniformly defined for one batch of products released at approximately the same time in the approximately the same region. The base configuration may include information regarding predefined display components, predefined floor plans, predefined user interface building blocks, and other components for the business application 110. The base configuration 121 may be shared among the client 175 and other systems via the network 148. In general, the base configuration 121 may represent a default, or standard, set of UIBBs that will be displayed for a particular application. In some implementations, the base configuration 121 may be associated with the environmental context 120, for example, including regional information such as country and time zone. The regional information of the base configuration 121 may enable the set of UIBBs to correctly display the formats of particular addresses, times, and other context-specific presentations of information according to the current environmental context 120.

The adaptation configuration 123 may include an adaptation schema 125. The adaptation schema 125 may include an array of dimensions 127. The dimensions 127 may include a set of adaptation context 129 that defines each entry of the dimensions 127. The adaptation configuration 123 may be applied to supplement, replace, or modify at least a portion of a corresponding base configuration 121. The adaptation configuration 123 may have a similar data structure and include a similar set of categories as the base configuration 121, such as the information regarding predefined display components, predefined floor plans, predefined user interface building blocks, and other components for the business application 110. The adaptation configuration 123 may further include an adaptation schema 125. The adaptation schema 125 can be a list of characteristics that can be used for adaptations. In some implementations, the adaptation schema 125 may include definitions such as, for example, role, country, and other characteristics. These characteristics may further be described as a set of dimensions 127, included in the adaptation schema 125.

Each entry of the adaptation dimensions 127 may represent an individual characteristic within an adaptation schema 125. For example, a dimension may be defined by a name for identification, an index for determining the dominating adaptation dimension in case of a conflict, a data element for providing a field that helps to configure context-based adaptations in design-time, and other entry types. The adaptation dimensions 127 may include entries of an adaptation context 129. The adaptation context 129 may be a set of characteristics values for a given adaptation schema. For example, if the adaptation schema 125 includes two entries of adaptation dimensions 127, such as role and country, for example, then the adaptation context 129 may be of values such that role=manager, and country=France.

In some implementations, the context-based adaptations may employ inheritance features of component configurations such that the adapted configuration is represented by a derived configuration. For example, a difference quantifier may document the differences between the adaptation configuration 123 and the base configuration 121. The difference quantifier may be included in the adaptation configuration 123 as an analyzed result performed by the context/environment analyzer 133. The difference quantifier may be executed using the configuration update module 131 and/or the adaptation engine 141.

The context/environment analyzer 133 may receive the adaptation context 129 of the dimensions 127 and compare the adaptation context 129 with the base configuration 121. The analyzer 133 may generate an analysis report for the adaptation engine 141 to identify the components that need modification during publication process. For example, the analysis results may include changes to UIBBs, such as the content, deployment properties, etc. Upon request, the adaptation engine 141 may communicate with the FPM to create and/or adapt UIBBs to fit the specifications defined in the adaptation configuration 123.

The illustrated environment 100 of FIG. 1 also includes one or more clients 175. The clients 175 may be associated with a particular business application or development context. Each client 175 may be any computing device operable to connect to or communicate with at least one of the context-based adaptation server 103 using a wireline or wireless connection via the network 148, or another suitable communication means or channel. In some instances, the client 175 may be a part of or associated with a business process involving one or more of the business applications 110, or alternatively, a remote developer or user associated with the business application 110 modifying the UIBBs associated with the business application 110. In general, each client 175 includes a processor 181, an interface 178, a client application 184, a graphical user interface (GUI) 190, and a memory 187. In general, the client 175 comprises an electronic computer device operable to receive, transmit, process, and store any appropriate data associated with the environment 100 of FIG. 1. It will be understood that there may be any number of clients 175 associated with, or external to, environment 100. For example, while illustrated environment 100 includes a single client 175, alternative implementations of environment 100 may include multiple clients communicably coupled to the one or more of the systems illustrated. In some instances, one or more clients 175 may be associated with administrators of the environment, and may be capable of accessing and interacting with the settings and operations of the configuration update module 131, one or more business applications 110, and/or other components of the illustrated environment 100. Additionally, there may also be one or more additional clients 175 external to the illustrated portion of environment 100 capable of interacting with the environment 100 via the network 148. Further, the terms “client” and “user” may be used interchangeably as appropriate without departing from the scope of this disclosure. Moreover, while each client 175 is described in terms of being used by a single user, this disclosure contemplates that many users may use one computer, or that one user may use multiple computers.

The GUI 190 associated with each client 175 may comprise a graphical user interface operable to, for example, allow the user of a client 175 to interface with at least a portion of the business application 110, configuration update module 131, and/or their associated operations and functionality. Generally, the GUI 190 provides the particular user with an efficient and user-friendly presentation of business data provided by or communicated within the system. The GUI 190 may comprise a plurality of customizable frames or views having interactive fields, pull-down lists, and buttons operated by the user. For example, the GUI 190 may provide interactive elements that allow a user to interact with a particular component within and/or external to environment 100. Different portions of the corresponding component's functionality may be presented and accessible to the user through the GUI 190, such as through a client application 184 (e.g., a web browser). Generally, the GUI 190 may also provide general interactive elements that allow a user to access and utilize various services and functions of a particular component. In some instances, the client application 184 may be used to access various portions of the context-based adaptation server 103. In some instances, the client application 184 may be an agent or client-side version of the business application 110 or other suitable component. The GUI 190 may present the information of the client application 184 for viewing and interaction. In general, the GUI 190 is often configurable, supports a combination of tables and graphs (bar, line, pie, status dials, etc.), and is able to build real-time portals, where tabs are delineated by key characteristics (e.g., site or micro-site). Therefore, the GUI 190 contemplates any suitable graphical user interface, such as a combination of a generic web browser, intelligent engine, and command line interface (CLI) that processes information in the platform and efficiently presents the results to the user visually.

As used in this disclosure, each client 175 is intended to encompass a personal computer, touch screen terminal, workstation, network computer, kiosk, wireless data port, smart phone, personal data assistant (PDA), one or more processors within these or other devices, or any other suitable processing device. For example, each client 175 may comprise a computer that includes an input device, such as a keypad, touch screen, mouse, or other device that can accept user information, and an output device that conveys information associated with the operation of one or more business applications 110, 166, configuration update module 131, and/or the client 175 itself, including digital data, visual information, or the GUI 190. Both the input and output device may include fixed or removable storage media such as a magnetic storage media, CD-ROM, or other suitable media, to both receive input from and provide output to users of client 175 through the display, namely, the GUI 190. The client's processor 181, interface 178, and memory 187 may be similar to or different from those described in connection with the other components illustrated in FIG. 1, although alternative implementations of one or more of these components may be used, as well as implementations where additional components may also be included.

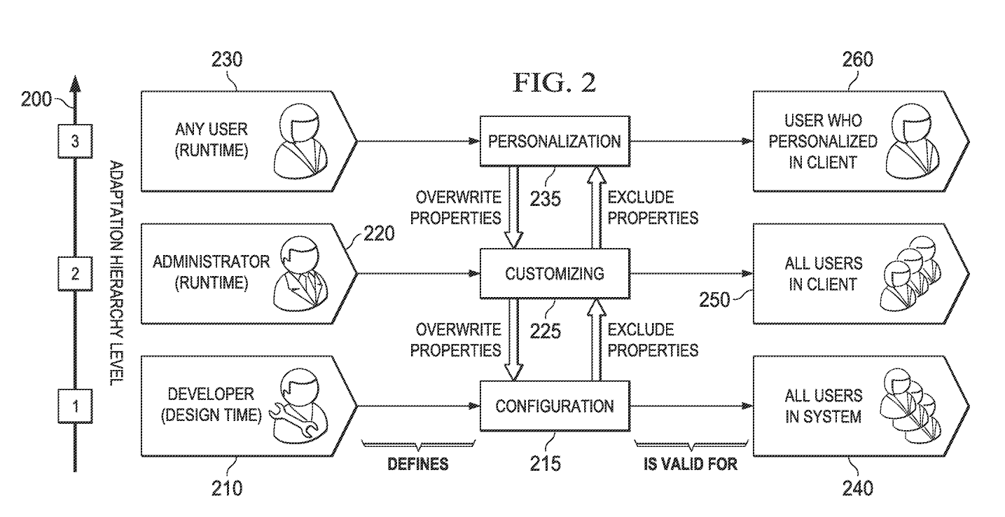

FIG. 2 provides an example illustration of an adaptation implementation hierarchy 200. The adaptation implementation hierarchy 200 may be applicable to the application controller 143 shown in FIG. 1. The adaptation implementation hierarchy 200 may include three levels of initiation entities for creating context-based adaptations: developer 210, administrator 220 and any user 230. The process for these three entities creating a context-based adaptation may be respectively classified as configuration 215, customizing 225, and personalization 235. The major differences between each of the three entities are concerning the excluding and overwriting properties. For example, in configuration 215, the developer 210 may exclude certain properties at design time from administrators 220, and the developer 210 may have the administrative right to overwrite certain properties submitted by administrator 220. Similarly, in customization 225, the administrator 220 may exclude certain properties at design time from any user 230 and the administrator 220 may have the administrative right to overwrite certain properties submitted by any user 230.

The developer 210 may deploy the adapted configuration 215 to all system users 240. All system users 240 may include the administrator 220 and any user 230. The developer 210 may apply the context-based adaptations to the configuration 215 at design time before and/or after the distribution to the all system users 240. The administrator 220 may deploy the adapted customization 225 to all client users 250. All client users 250 may include any user 230. The administrator 220 may apply the context-based adaptations to the customization 225 at runtime before and/or after the distribution to all client users 250. Any user 230 may deploy the adapted personalization 235 to personalized client users 260. The personalized client users 260 may be a particular group of users specialized in certain aspects of operation and requires a very specific user interface. Any user 230 may apply the context-based adaptations to the personalization 235 at runtime before and/or after the distribution to the personalized client users 260.

As illustrated in FIG. 2, the implementation hierarchy 200 therefore explains that context-based adaptation may be deployed at both design time and runtime, by different entities (i.e. the developer 210, the administrator 220, and any user 230.) The adaptation configurations created by these entities may also be distributed to affect a variety of audiences (i.e. all system users 240, all client users 250, and personalized client users 260). For example, the adaptation schema 125 of FIG. 1 may be created at all three levels to target a particular audience, such as users within an industry, a company, a department, a sales group, etc. The adaptation schema 125 may be deployed widely without concern for the particular audience because the adaptation configuration (such as the adaptation configuration 123 in FIG. 1) is context-based, executed when the business application 110 is running in an environment (such as the industry, the company, the department, the sales group, or another predefined context, for example) that evokes the implementation of the adaptation configurations.

For example, at design time, the developer 210 may create an adaptation schema that includes dimensions of roles and country, such that role=manager and country=France. The adaptation configuration may be distributed as the adapted configuration 215 to all system users 240, including system users in multiple different roles and countries. The business application may use the base configuration adapted with the adaptation configuration only for the users that are managers and in France, without applying the adaptation configurations to other users. Among the managers in France, another adaptation configuration may be created with an adaptation schema for senior managers, the adaptation schema created by an administrator. This level of adaptation may be deployed at runtime to affect the UIBBs of those senior managers in France. Such configuration automation enables efficient deployment and modification of business applications, saving time and cost.

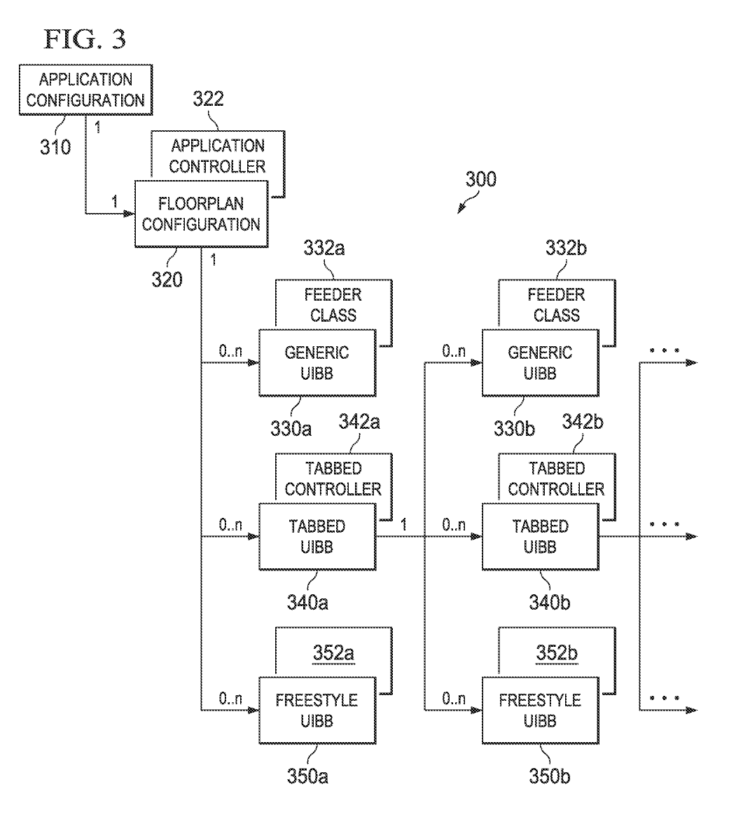

FIG. 3 illustrates an example configuration 300 at various execution levels. The example configuration 300 may be applicable to both the base configuration 121 and the adaptation configuration 123 illustrated in FIG. 1 in terms of execution levels and structures. The example configuration 300 may include an application configuration 310. The application configuration 310 may include a floor plan configuration 320. The floor plan configuration 320 may include one object instance floor plan, one guided activity floor plan, or one overview page floor plan. The floor plan configuration 320 may be implemented with an application controller 322, which may be the application controller 143 in FIG. 1. The different components in the floor plan configuration 320 may implement common behaviors for business applications. These components may serve as templates and application-specific settings may be stored within the floor plan configurations 322.

One type of important information within the floor plan configuration 322 is a list of embedded components used for displaying application data. These components may be structured as the generic UIBB 330a, tabbed UIBB 340a, and freestyle UIBB 350a, as illustrated in FIG. 3. The generic UIBB 330a may be provided by an FPM-related framework. The generic UIBBs 330a may implement common behavior defined by user interface guidelines. The freestyle UIBBs 350a may include adapted views that may be static and specific for an intended application. The tabbed UIBB 340a may be a level indicator extending a sublevel that includes another set of UIBBs such as the generic UIBB 330b, tabbed UIBB 340b, and freestyle UIBB 350b. As illustrated in FIG. 3, the floor plan configuration 320 may include at two and more levels of UIBBs that defines execution of adaptation configurations. The configuration hierarchy may then be applied to business applications tailored for specific requirements.

Programming codes may be executed behind each UIBB. For example, a feeder class 332a may be running for the generic UIBB 330a. A tabbed controller 342a may be running behind the tabbed UIBB 340a for controlling the lower level of UIBBs, such as the generic UIBB 330b, the freestyle UIBB 350b, and the tabbed UIBB 340b. The generic UIBB 330b and the tabbed UIBB 340b have their own execution codes: feeder class 332b and tabbed controller 342b, respectively. The freestyle UIBBs 350a-b may include their respective execution codes 352a-b (inside the freestyle UIBBs 350a-b in FIG. 3). Although FIG. 3 illustrates two sublevels of floor plan configuration 320, more UIBBs may be structured behind the tabbed UIBB 340b.

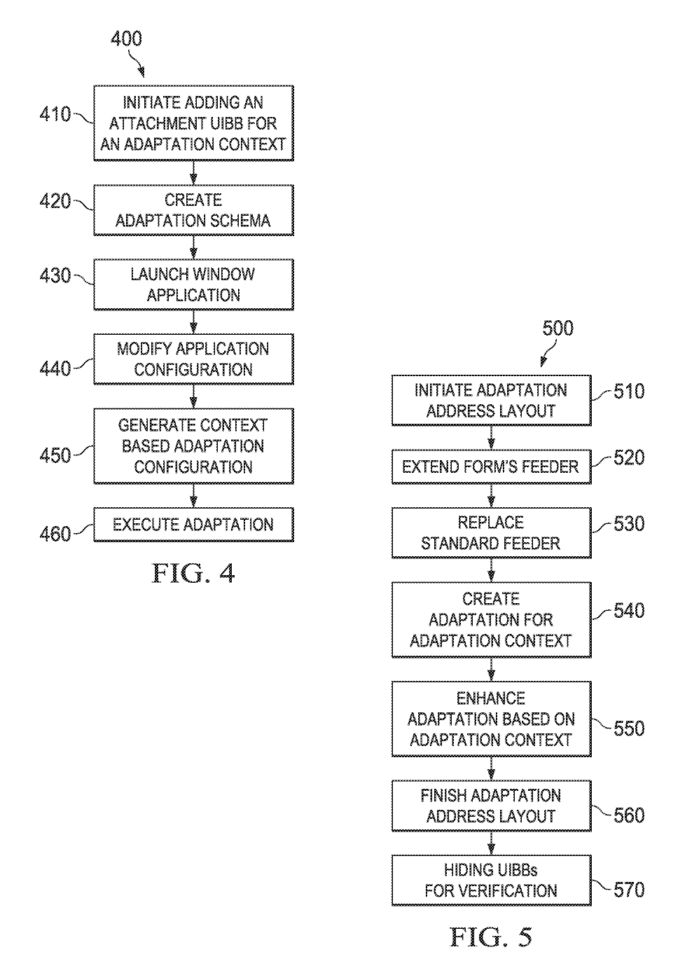

FIG. 4 is a flowchart of an example method 400 for adding an attachment user interface building block (UIBB) for an adaptation context. An attachment UIBB may be added to a particular user interface to allow users to add or submit documents or other unstructured data with the information submitted in the corresponding user interface. At 410, the process of adding an attachment UIBB for a particular adaptation context is initiated. The particular adaptation context may be the adaptation context 129, a value in the adaptation dimensions 127 included in the adaptation schema 125, as illustrated in FIG. 1. The initiation at 410 evokes the next operation 420, in which an adaptation schema is created. The adaptation schema may include a list of dimensions in which application context values can be defined. For example, a schema input interface may be launched so that the adaptation context can be input for each dimension entry.

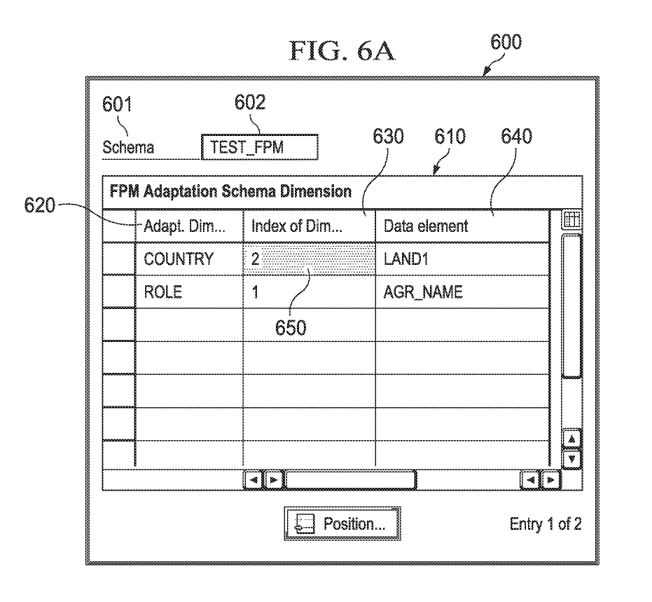

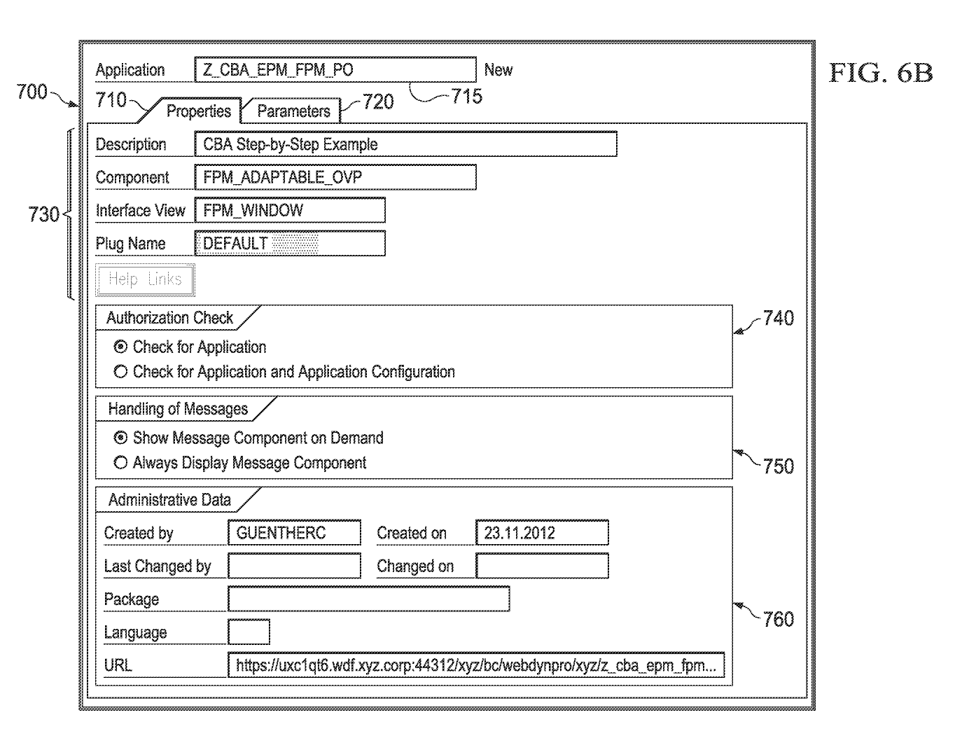

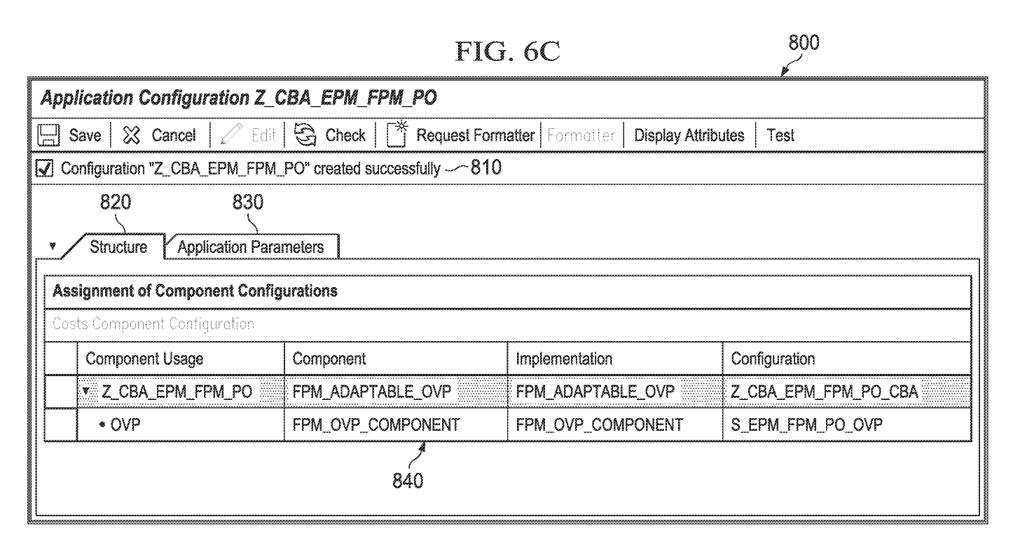

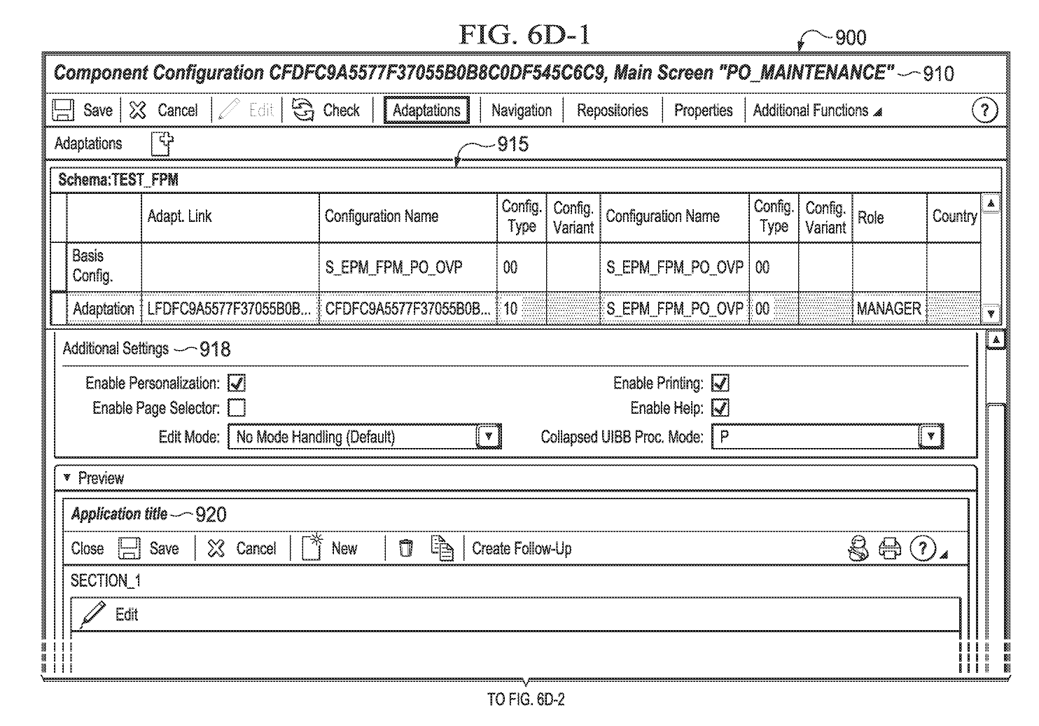

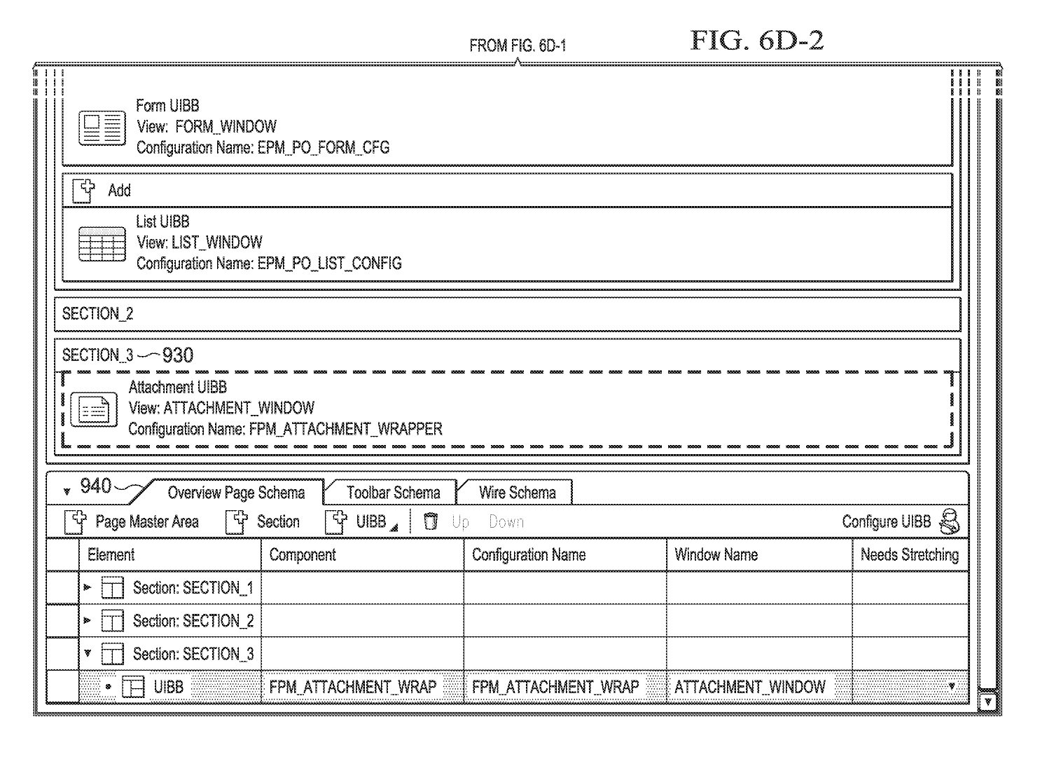

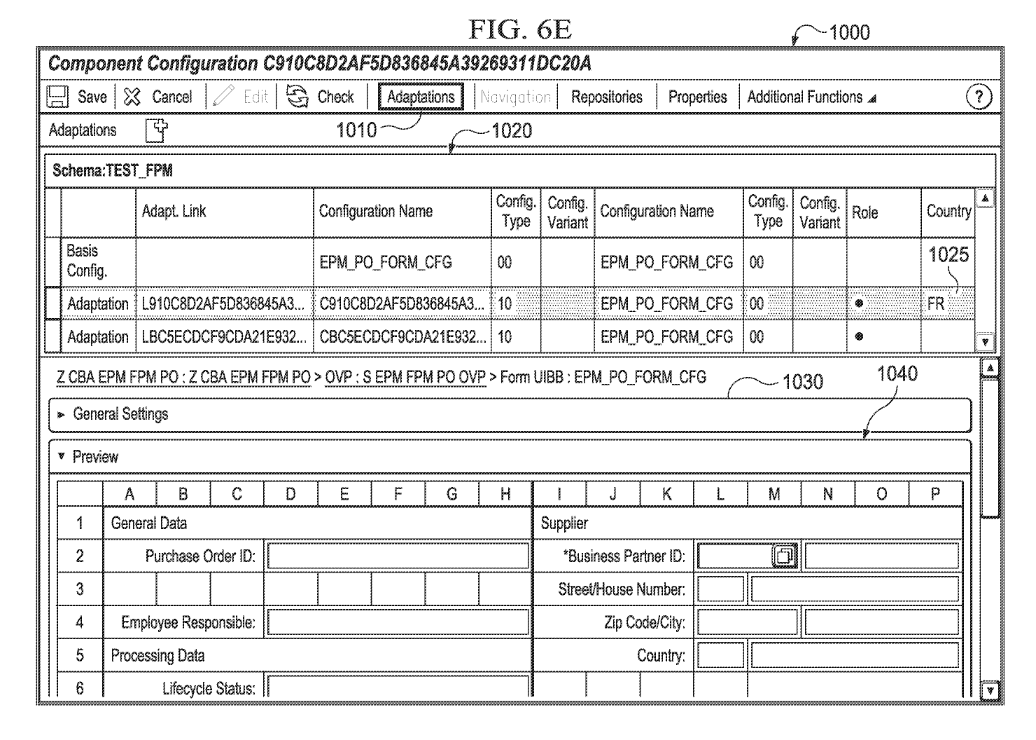

In some implementations, the UIBBs may be added or removed without any modification to the existing business application. This may save computation cost for creating a copy or backup of the original configuration. At 420, the adaptation schema may be created as shown in an example user interface 600 of FIG. 6A. The example user interface 600 may include two display options: the schema 601 and the test floor plan manager 602. These two options may allow users to switch views. A window of FPM adaptation schema dimension 610 is displayed including a form to be filled. The window as illustrated in FIG. 6A may include a column of adaptation dimensions 620, a second column of index of dimensions 630, and a third column of data element 640.

In the example user interface 600 of FIG. 6A, the adaptation dimensions 620 may include two entries 650: country and role. The index of dimensions 630 may use numerical numbers to reflect the order of each entry 650. The corresponding field in the data element 640 may include values for each entry 650, the values are the adaptation context. The example interface 600 may generated by launching SM30 with a code FPM_V_ADAPT_SCHM. The adaptation schema 610 may be valid throughout a whole application area. This may save computational cost from creating an individual schema for every application.

Returning to FIG. 4, a new window application may be launched at 430. The new window application may enable definitions of component, interface view, plug name, and other properties, such as authorization check, handling of messages, administrative data, etc. At 440, the application configuration can be modified. The application configuration may be modified with sufficient data describing the adaptation context. The application configuration may include the original application's root component application.

In some implementations, the new window application launched at 430 may be created before setting the adaptation configuration. An application adaptation can be created and/or defined through the user interface 700 shown in FIG. 6B. The user interface 700 may include two tabs allowing users to define properties 710 and parameters 720 for a particular application. The new window application may be assigned in the top text box 715. The definition entries 730 may include description, component, interface view, and plug name descriptions.

As illustrated in FIG. 6B, an authorization check option 740 is provided in the user interface 700. The authorization check 740 may be applied for the running application, or be applied for the running application and its configuration. A handling of messages option 750 may enable selection between whether a message component is shown on demand, or shown always. The user interface 700 may further include a set of administration data 760. The administration data 760 may include the adaptation author, created date, modification date, modification author, related package, language, and a URL, each allowing users to determine how and when a particular adaptation was defined or created. In some cases, in order to allow to set the adaptation context via URL parameters or via application configuration, the relevant adaptation dimensions are added as application parameters.

In some implementations, at 440, the application configuration can be created with a user interface 800 as shown in FIG. 6C. The user interface 800 may show the status for the configuration creation. For example, the field 810 shows that a configuration entitled “Z_CBA_EPM_FPM_PO” has been created successfully. The user interface 800 may include two option tabs: one is the structure tab 820, and the other is the application parameters tab 830. As shown in FIG. 6C, the structure tab 820 may include an assignment of component configurations 840. For example, the assignment 840 may include descriptions for component usage, components, implementations, and configurations. In the example shown in FIG. 6C, there are two component configurations shown in 840.

At 450, the context-based adaptation configuration can be generated. In some implementations, certain attributes may be required to be maintained. Components may need to be defined at this step, such as describing configuration context with elements that include configuration data, selecting attributes of the element configuration data by defining the originated schema, and selecting built-in modules. At 460, the context-based adaptation may be created with execution of the previous preparations. The application configuration may be called up and navigated to the open virtual platforms component configuration. A button may be designed or provided to allow switching on and off the adaptation view. New UIBBs can be added and saved in the updated adaptation view. Relevant adaptation context may be set and saved as URL parameters. A plurality of adaptation contexts can be associated with a particular application, providing variations to UIBBs according to the current context.

At 460, the adaptation configuration may be implemented and creating a new example preview screen 900 including general adaptation configuration information associated an adaptation configuration being modified as illustrated in FIG. 6D. This may be accomplished by calling up the new application configuration and navigating to the component configuration. There is a toggle button “adaptations” for choosing to display the adaptation interface. In the previous examples where the adaptation schema may include two dimensions “role” and “country”, if an adaptation is to be created for managers (being the adaptation context for role), a user may use the “add adaptation” function and enter “manager” as role in the pop-up window. A second entry in the adaptation list can be obtained and selected to enter an editing mode. The example window 900 shows the result of adding the new adaptation.

The window 900 may include a title 910 showing the particular component configuration being viewed and/or edited. A schema block 915 may record the parameters of the schema TEST_FPM, which include information on the base configuration and the current adaptation configuration being modified. Information on the configuration name, type, variant, adaptation link, dimension values, and others are included. Specifically, the adaptation configuration information can include at least some of the dimensions in which the adaptation configuration will be used, thereby providing users with a view as to the environmental context required to trigger the use of the particular adaptation configuration. An additional settings block 918 may enable selection of additional adaptation-related settings, which can include choosing to enable personalization, printing, help, page, display mode, etc. A preview pane 920 may be included in the window 900 to preview the adapted window to illustrate what the application or component would present when the adaptation configuration is applied. The highlighted portion 930 shows the additional attachment that is included when the environmental context matches the adaptation context that is defined (such as role=manager and country=France). The other two sections above the highlighted portion 930 show the UIBBs associated with the base configuration. The activation information is summarized in the bottom window 940.

FIG. 5 is a flowchart of an example method 500 for initiating an adaptation address layout. The method 500 may enable dynamic adjustment of the UIBB screen layout based on the adaptation context and the data to be displayed or that is received as input. Similar operations to portions of those performed by method 500 can be used to allow for dynamic adjustments and modifications to UIBBs based on both the current context in which the UIBB is being presented, as well as the information being presented or that is associated with the UIBB at a particular time or in a particular instance.

At 510, the process for adapting an address layout may be initiated. At 520, a form's feeder may be extended by calling data acquisition of the parent class. In addition, an event id may be checked to avoid forming an infinite loop. Thirdly, a specific context value may be provided and delivered by the standard feeder. An object to set the application context may then be created. The adaptation context may be set via event parameters. Finally, the event may be created.

At 530, the standard feeder can be replaced in the adaptation. An adaptation may be created to replace the standard feeder with the created one. Applications that require adaptation functionality may include certain code in addition to the standard code. Any suitable programming language or technique may be used to cause the replacement. At 540, an adaptation for an adaptation context can be created. By replacing the feeder (at 530), different field values may be fitted appropriately according to different formats (i.e., from the base configuration format to the adaptation configuration format). This may be applied to a particular UIBB or all UIBBs depending on the UIBB that is affected by the adaptation configuration.

At 550, the application may be enhanced based on the adaptation context. At this operation, unnecessary FPM events may be designed to be avoided. For example, checking if the application can accept a context-based adaptation may avoid some FPM events. In addition, additional FPM events can be limited by storing the adaptation context at every event and checking if any changes occur in the net event. A trigger may be created for adaptation events by calling a get-data method of the standard feeder class and only executing the context-based adaptation processing when the adaptation is active. The adaptation context may be set locally for a single UIBB. This can be realized by adding the UIBB instance key to the event and using an appropriate event. Another private attribute may be added to the feeder. Then, the adaptation event may be triggered locally.

At 560, the adaptation address layout can be completed by raising the event of which the UIBB is set for the adaptation context. An addition verification operation may be applied to examine that the adaptation context is applied locally. At operation 570, UIBBs can be hidden to reveal the portion created by the adaptation context for verification of the adapted configuration. For example, another identical adaptation configuration may be created but not applied, and the application layout of the two can be compared and reveal the UIBB changed by the adaptation configuration. This operation may be applied during runtime, as dynamic changes of the adaptation context may affect adaptations of UIBB configurations.

In some implementations, the adaptation address layout may be executed for a French address in an example 1000 shown in FIG. 6E. In this example, a form especially for the adaptation context country=FR is shown. In this example 1000, the application may have a switch button 1010 enabling an adaptation view. A selection panel 1020 may enable selection of different characteristics. In this example 1000, the characteristic country=FR 1025 is selected. A number of settings may be defined in a general setting panel 1030 before viewing the adapted interface. The preview window 1040 enables users to preview the UIBB in the adaptation configuration. In one example, a master/detail behavior of an application may use similar functionality. In that example, a top-level table may include different objects, where the details for a particular selected object are shown below the top-level table. Depending on the context of the selected object, the corresponding adaptation is applied within the detail-related area.

The preceding figures and accompanying description illustrate example processes and computer implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously, concurrently, and/or in different orders than as shown. Moreover, environment 100 may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method for providing context-based adaptation to user interfaces, the method comprising:
identifying an executing instance of an application associated with at least one adaptation configuration, each adaptation configuration associated with a set of context criteria;
determining an environmental context associated with executing instance of the application;
receiving a request to perform an operation of the application;
comparing the determined environmental context with at least one adaptation configuration to determine if the determined environmental context satisfies the set of context criteria associated with at least one adaptation configuration; and
applying the at least one adaptation configuration for the performance of the operation based on the environmental context satisfying the set of context criteria associated with the at least one adaptation configuration.

2. The method of claim 1, wherein the set of context criteria is defined in an adaptation schema.

3. The method of claim 1, wherein the application is associated with a default base configuration.

4. The method of claim 3, wherein at least one adaptation configuration is further associated with at least one modification rule defining at least one modification to the base configuration of the application.

5. The method of claim 4, wherein applying the at least one adaptation configuration comprises executing the at least one modification rule on the base configuration.

6. The method of claim 4, wherein the modification rule is associated with an adaptation to the user interface of the application presented to users.

7. The method of claim 4, wherein the modification rule is associated to the operation of the application.

8. The method of claim 1, wherein at least a portion of the set of context criteria including user input evaluated at runtime.

9. The method of claim 1, wherein the adaptation configuration comprises:
an adaptation schema comprising a plurality of dimensions; and
a plurality of adaptation contexts correspondingly defining the plurality of dimensions, the plurality of adaptation contexts being a subset of the environmental context.

10. The method of claim 1, wherein the adaptation configuration is designed, modified, and initiated by at least one of an application developers, system administrators, or application users.

11. The method of claim 1, wherein the application is running within an environment context, wherein available base configurations are applied, the base configurations supporting the adaptation configuration at runtime.

12. A computer program product for providing context-based adaptation to user interfaces, the product comprising computer readable instructions embodied on tangible, non-transitory media, the instructions operable when executed to:
identify an executing instance of an application associated with at least one adaptation configuration, each adaptation configuration associated with a set of context criteria;
determine an environmental context associated with executing instance of the application;
receive a request to perform an operation of the application;
compare the determined environmental context with at least one adaptation configuration to determine if the determined environmental context satisfies the set of context criteria associated with at least one adaptation configuration; and
apply the at least one adaptation configuration for the performance of the operation based on the environmental context satisfying the set of context criteria associated with the at least one adaptation configuration.

13. The product of claim 12, wherein the set of context criteria is defined in an adaptation schema.

14. The product of claim 12, wherein the application is associated with a default base configuration.

15. The product of claim 14, wherein at least one adaptation configuration is further associated with at least one modification rule defining at least one modification to the base configuration of the application.

16. The product of claim 15, wherein applying the at least one adaptation configuration comprises executing the at least one modification rule on the base configuration.

17. The product of claim 15, wherein the modification rule is associated with an adaptation to the user interface of the application presented to users.

18. The product of claim 15, wherein the modification rule is associated to the operation of the application.

19. The product of claim 12, wherein at least a portion of the set of context criteria includes user input evaluated at runtime.

20. The product of claim 12, wherein the adaptation configuration comprises:
an adaptation schema comprising a plurality of dimensions; and
a plurality of adaptation contexts correspondingly defining the plurality of dimensions, the plurality of adaptation contexts being a subset of the environmental context.

21. A system comprising:
one or more computers; and
a computer-readable medium coupled to the one or more computers having instructions stored thereon which, when executed by the one or more computers, cause the one or more computers to perform operations comprising:
identifying an executing instance of an application associated with at least one adaptation configuration, each adaptation configuration associated with a set of context criteria;
determining an environmental context associated with executing instance of the application;
receiving a request to perform an operation of the application;
comparing the determined environmental context with at least one adaptation configuration to determine if the determined environmental context satisfies the set of context criteria associated with at least one adaptation configuration; and
applying the at least one adaptation configuration for the performance of the operation based on the environmental context satisfying the set of context criteria associated with the at least one adaptation configuration.
